(19) United States
(12) Patent Application Publication
(10) Pub. No.: US 2009/0255107 A1
(43) Pub. Date: Oct. 15, 2009

(54) PIPING ALIGNMENT DEVICE AND METHOD

(76) Inventor: Gary Griffith, Muncie, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/420,987

(22) Filed: Apr. 9, 2009

Related U.S. Application Data
(60) Provisional application No. 61/043,559, filed on Apr. 9, 2008.

(51) Int. Cl. B23P 11/00; B25B 27/14

(52) U.S. Cl. 29/464; 29/271

(57) ABSTRACT

An apparatus is presented for providing vertical or horizontal alignment to a pipe or conduit extending through a floor, wall or ceiling surface, comprising a box-like housing having a first set of one or more openings extending therethrough, one or more pipe stubs for extending through the first set of one or more openings of the housing for receiving partially therein the pipe or conduit, and elastomeric members for securing the pipe stubs within the openings of the housing and to provide a fluid-tight seal therebetween. The alignment device is adapted to be positioned within the floor, wall or ceiling surface, respectively, through which the pipe or conduit is to extend. The number, location and size of the stub openings can be varied to accommodate piping systems of varying sizes and configurations, and may be determined on a case-by-case basis prior to construction, relying on customized pipe fittings as well as standardized models for masonry construction and wood-frame construction. Other embodiments of the invention may consist of multiple openings of various dimensions, aligned in the center of the housing or in combinations suitable for specific pipes and other variations.

### CROSS REFERENCE TO RELATED APPLICATIONS

This application claims the benefit of priority to U.S. Provisional Patent Application Ser. No. 61/043,559, filed Apr. 9, 2008, titled PIPING ALIGNMENT DEVICE, incorporated herein by reference.

### FIELD OF INVENTION

This invention relates to building components and alignment devices used in building construction and, more particularly, provides a “plumb box” device and method that facilitates the true vertical/horizontal alignment of generally tubular objects, such as piping or conduits, during the construction of a building structure.

### BACKGROUND OF THE INVENTION

When designing a residential or commercial structure, the architect typically uses dimensioned drawings to outline most aspects of construction. Plumbing, electrical and other types of pipes, conduits and cables, typically have pre-determined locations (i.e., within future or existing wall, ceiling, or floor systems), as well as appropriate connection points. Despite this forethought, the current technique for placing and positioning such systems during construction is often prone to error and misalignment, or becomes difficult and time consuming given various uncontrollable environmental factors primarily on an open-air building construction site. Plumbing pipes, for instance, tend to be installed as a long unit, often within, under, or through the floor of the structure, with concrete subsequently being poured around and over them. Horizontal runs of such piping are often connected to vertical runs of piping that are often intended to fit within predetermined, but yet-to-be-built, wall systems.

Currently, the installation and alignment process is primarily a manual operation, whereupon an installer positions a pipe or conduit vertically or horizontally using a leveling device, and then simply secures the pipe or conduit in place or “plumbs” it with stakes and tape. The accuracy of this operation (i.e., positioning and alignment) at the early stages of the building construction process becomes critical at the later stages as floors, walls, and ceilings start to be built and everything must fall into proper alignment according to the original drawings. Inaccuracies can be extremely costly, in terms of time, materials and additional needless expense.

The device provided by this invention and its method of installation anticipates the importance of the positioning of piping and conduit systems corresponding to predetermined points in space, as well as the critical importance of vertically positioned systems to be truly vertical or “plumb.” This invention accomplishes these objectives by increasing the efficiency and accuracy of the positioning, aligning and installing of such systems, thereby reducing time, error and needless additional cost during the building construction phase.

### SUMMARY OF THE INVENTION

This invention serves as a horizontal/vertical alignment device for pipes and conduit of varying shapes and sizes for use in building construction. It also serves as a connection hub for such piping, allowing a user to make bends and connections between floors, ceilings and walls. Rather than having to measure and re-measure the alignment of materials and stake them into place—a time-consuming method oftentimes prone to error—this invention allows for a stable alignment of piping and conduits on a ready-made basis. The invention is lined up flush with the floor or wall system prior to construction, whereby a true “plumb” alignment is readily achieved.

A preferred embodiment of the invention comprises a box-like housing structure with various openings that accommodate pre-installed piping (sometimes referred to as “stubs” in the building industry). Once the invention is installed on the construction site, the stubs provide level and plumb connection points for vertically or horizontally aligned piping. The pre-installed piping stubs can be placed in various configurations to extend straight through floor, ceilings and walls; or configured to provide a bend or joint. This invention overcomes the shortcomings and problems that currently exist with the installation of piping materials in commercial and residential buildings.

The assembly provided by this invention comprises the box-like housing preferably constructed from a plastic polymer or other solid material. The housing has variable dimensions that can be selected and customized prior to construction, as determined by the contractor or installer. More common dimensions match commonly used construction systems for floors and walls. For example, a conventional base unit to be used in masonry construction has an average size measuring 7⅝ inches deep, 7⅝ inches across, and 15⅝ inches in length. Other sized housings can also be accommodated according to wall or floor construction standards.

The preferred housing of this apparatus is provided with one or more sets of openings or holes to accommodate the pipe “stubs” extending through the housing. The sides or vertical surfaces of the housing preferably have connection mechanisms arranged thereon to provide modularity, thereby allowing two or more housings to be coupled together to form a single, larger housing structure. Such a connection mechanism facilitates the expandability of this invention without the need for additional tools and hardware.

The piping “stubs” extend preferably through the entire length of the housing structure. Rubber grommets or washers may be used to secure and protect the outer connection points between the housing and the pipe stubs. Additionally, these grommets or washers maintain an air seal between the housing and pipe to prevent the flow of air in case of fire (commonly known as a “fire-stop” in the building industry), as well as dampening the effect of vibrations and noise. One or more corners of the housing may be provided with openings therethrough for set screws, spikes, or other elongated components to be threaded or otherwise secured through the body of the housing and into the ground or other base structure for positioning and stabilizing the housing once installed.

The piping alignment invention described and claimed herein has other uses, including but not limited to electrical, HVAC and telecommunications, where alignment of pipes and conduit are equally as important. Any plumbing or other system, such as those listed above, that requires a squaring or “plumb” alignment during installation and that runs through and aligns with walls and floor systems that will be constructed at later phases in the construction process will benefit from this invention. These other types of systems (in addition to plumbing systems) are just as susceptible to damage or misalignment and, thus, benefit from this invention equally as well.

In use during construction of any building or structure, the proper alignment of pipes or other conduits is subject to being compromised by a variety of factors, including but not limited to: intentional or unintentional actions or adjustments by other member of the construction crew; an inability for the current staking installation process to keep proper alignment; accidental movement due to other phases of the construction process; or a variety of other factors that may be outside of the control of the installer. For example, another member of the construction crew different than the installer of the device may be responsible for pouring the concrete floors or securing wall and ceiling materials into place. Since the pipe is an entire unit, fixing the alignment issue may require considerable additional time and expense—possibly even the demolition and/or replacement of piping/conduit or adjacent building systems.

The device and method provided by this invention seeks to allow a ready-made solution to this problem by preventing misalignment issues before they happen, and represents a method for simplifying the installation of piping while simultaneously increasing the speed and accuracy of the installation.

### BRIEF DESCRIPTION OF THE DRAWINGS

FIG. 1 is a perspective view of the unassembled elements of a currently preferred embodiment of the alignment device provided by of this invention.

FIG. 2 depicts the alignment device of FIG. 1 in an exploded perspective view.

FIG. 3 is a partially cut-away perspective view of the preferred embodiment of FIG. 2 showing the interior and exterior of the invention once fully assembled.

FIGS. 4 and 5 are perspective views of alternative embodiments of this invention.

FIGS. 6A and 6B depict a currently preferred connection mechanism provided by this invention for assembling modular combinations to construct multiple housing structures.

FIGS. 7A, 7B and 7C present various embodiments of the invention showing the housing in varying sizes and equipped with openings of differing sizes and configurations.

FIG. 8 is a perspective cut-away view of the preferred embodiment of the invention of FIG. 2B installed in the floor of a building or home.

FIG. 9 is a perspective view of an embodiment of the invention installed in an interior wall of a standard masonry construction.

FIG. 10 is a perspective view of another embodiment of the invention installed in an interior wall of a standard wood-frame construction.

### DETAILED DESCRIPTION OF PREFERRED EMBODIMENTS

The following illustrations and descriptions are intended to provide a greater understanding of the uses and applications of the piping alignment device provided by this invention, hereinafter sometimes referred to for convenience as a “Plumb Box.” All references to the device, its embodiments, uses, applications and dimensions are provided as a way of clarifying the principles of the technology and its best modes of operation. It is asserted that the images provided and specific language chosen is in no way meant to limit the scope of the invention. Further alterations or modifications of the device may seek greater applications of the principles of the technology, as would be expected as part of developing the invention for practical use.

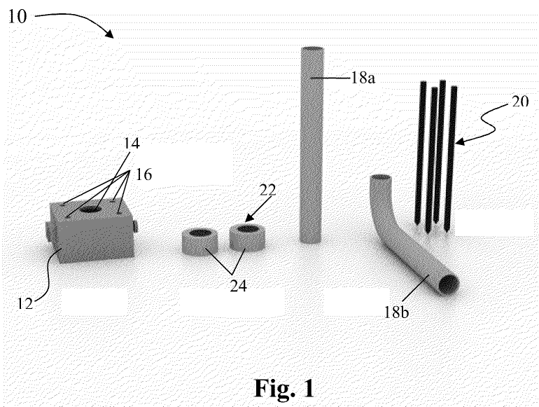

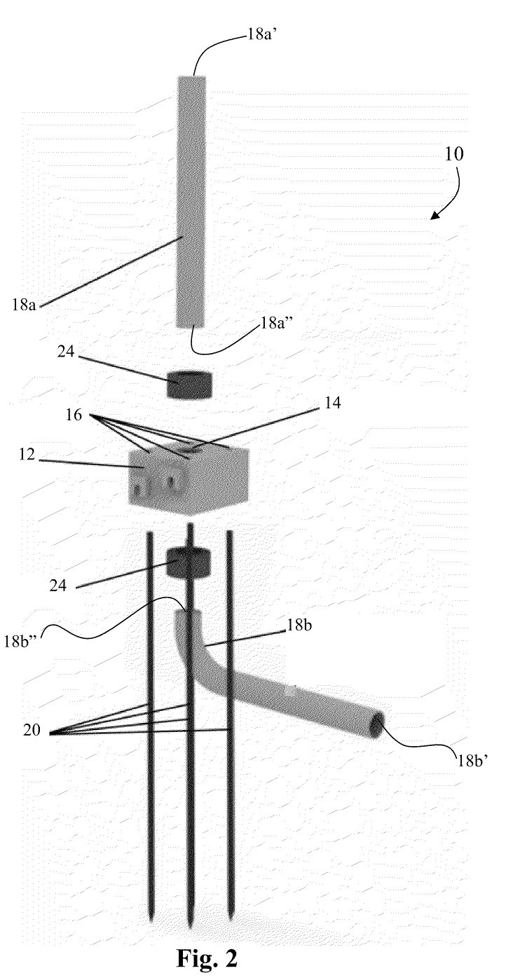

Shown in FIGS. 1-3 is one preferred embodiment of the Plumb Box apparatus 10 provided by this invention intended to accommodate a single pipe or conduit connection. Apparatus 10 preferably includes a box-like housing 12 having a first set of one or more openings 14 provided in one of its planar surfaces for receiving therethrough a pipe or conduit (not shown in FIG. 1) and one or more pipe stubs 18a, 18b extending through the opening 14 of the housing 12. In a preferred embodiment, the stubs extend only a short distance (preferably about 2 inches to about 3 inches) beyond the vertical or horizontal surfaces of the housing 12. In the embodiment shown in FIGS. 1-3, stub 18a extends entirely through housing 12 to extend slightly above and below the housing. A transition stub 18b is also provided to provide an accurate, plumb and ready-made vertical-to-horizontal transition for the piping system assisted by the device. As best shown in FIG. 2, the proximal end of 18a″ of stub 18a extends, once apparatus 10 is full assembled, slightly beneath housing 12 and is coupled to the proximal end 18b″ of transition stub 18b. Any conventional method of coupling the open ends of two (2) PVP pipes together may be used to couple the corresponding proximal ends of stubs 18a and 18b. When installed, the pipe or conduit then extends partially into the open distal ends 18a′ and 18b′ of the stubs for ready-made plumb alignment.

The alignment apparatus 10 further comprises means for stabilizing and securing the housing 12 in a fixed position within the floor, wall or ceiling surface through which the pipe or conduit is to extend. Such means can include a second set of openings 16 provided in the horizontal or vertical surfaces of the housing 12 and one or more stabilizers 20, such as elongated posts, stakes, screws, bolts or the like, which are intended to be received through the second set of openings 16 to fix housing 12 in position. Openings 16 are preferably located generally near one or more of the corners of housing 12. Such stabilizers may also be used on other areas of the apparatus 10 as may be needed for proper adjustment and stabilization.

Alignment apparatus 10 further comprises means 22 for securing the stubs 18 within the opening 14 of housing 12. Such means preferably comprises one or more elastomeric grommets or washers 24 that are positioned between the stubs 18 and the circumferential interior edge of opening 14. Means 22 further provides a fluid-tight seal between stubs 18 and the housing 12 to provide a “fire-stop” within the building structure once completed.

The stub opening 14 provided in housing 12 preferably conforms to standard piping diameter and dimensions. The stubs 18 are preferably PVC plumbing pipes, with other uses as needed for conduit used in different mechanical systems, such as electrical, communications or HVAC systems. The stub openings 14 can be fitted and molded for any conduit materials within the dimensions of the housing 12 and its average configurations. Stubs 18 are secured in housing 12 preferably with the grommets 24, which fit in connection with the various stub openings 14.

FIG. 2 shows an exploded view of the first preferred embodiment of the invention as it would be assembled from the components in FIG. 1 to define the alignment apparatus 10. The preferred unit is intended to align pipes vertically (as shown via stub 18a in this embodiment) or horizontally (as shown via stub 18b), depending on the placement of the housing 12 within a construction project. Stabilizers 20 extend through housing 12 to the ground or other base surface when the apparatus is used on flooring systems. Alternatively, screws or bolts may be used to stabilize the housing via openings 16.

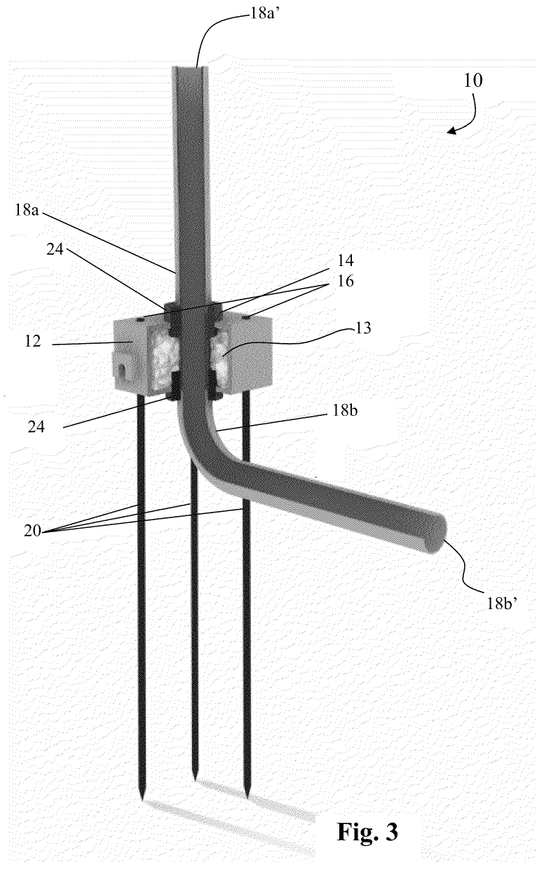

FIG. 3 shows a partial cross-section of the first preferred embodiment to illustrate the manner in which the elements of this invention are assembled internally within the apparatus 10. Grommets 24, preferably constructed from elastomeric material with some degree of elasticity, allow for slight lateral movements to avoid shearing or other possible mechanical failures of the stubs 18, such as may occur during a natural disaster. Also illustrated in FIG. 3 is a foam insulation infill 13 disposed within the internal cavity of housing 12 to improve rigidity and thermal properties of the apparatus 10. Such foam can be pre-installed or site-installed.

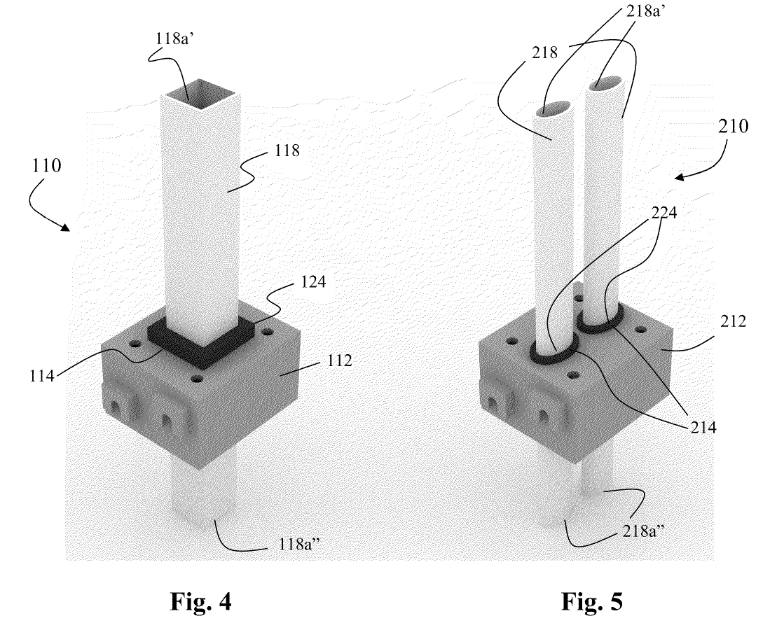

FIGS. 4 and 5 present alternative embodiments of this invention. In FIG. 4, apparatus 110 is shown including a housing 112 having a square opening 114 therein, through which a single stub 118 having a corresponding square cross-section extends. The opposing ends 118a′ and 118a″ of stub 118 extend both above and below housing 112, respectively. A similarly shaped elastomeric grommet or washer 124 is positioned between stub 118 and the interior edge of opening 114. Grommet 114 serves to allow for slight lateral movements of the piping to avoid shearing or other possible mechanical failure of stub 118, particularly in the event of a natural disaster such as an earthquake or the like, as well as serving as a fire-stop barrier.

FIG. 5 shows yet another embodiment of the invention wherein apparatus 210 includes a housing 212 having two (2) oval or elliptical openings 214 therein, through which two (2) stubs 218 having corresponding oval or elliptical cross-sections extend. The opposing ends 218a′ and 218a″ of stubs 218 extend both above and below housing 212, respectively. Similarly shaped elastomeric grommets or washer 224 are preferably positioned between stubs 218 and the interior edge of each opening 214. Grommets 224 serve similar functions as grommet 24 shown and discussed in relation to the embodiment of FIGS. 1-3 and grommet 124 shown and discussed in relation to the embodiment of FIG. 4.

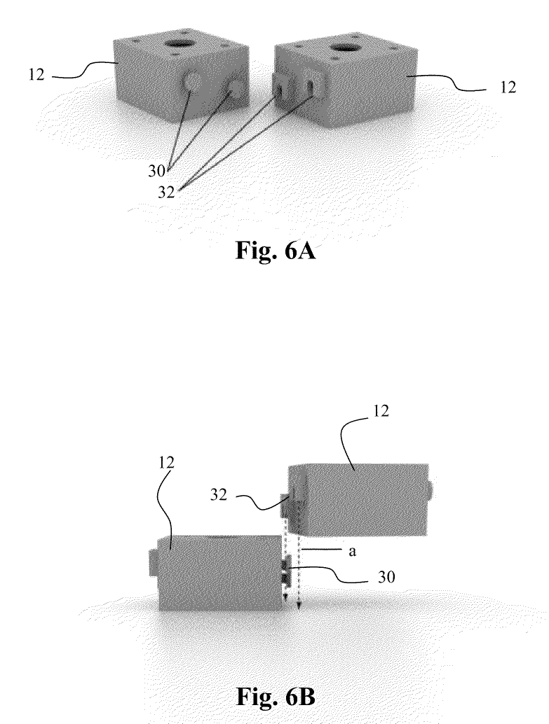

The Plumb Box alignment apparatus is also preferably constructed to be modular in that the installer may combine different embodiments of the housing 12 together into one larger unit to meet his on-site needs. FIGS. 6A and 6B show a connector provided on either side of the housing 12 (preferably on its vertical side surfaces) and how two (2) embodiments of the Plumb Box housing 12 can be combined into a larger, single unit by the installer on the construction site. In a preferred embodiment such a connector may be provided by a sliding mechanism defined by male and female sliding connectors 30 and 32, respectively, whereby the female connector 32 is slid down over the male lug connector 30 (as shown by reference arrows “a” in FIG. 6B) to removably secure the first and second housings to each other. Other conventional means of connecting or affixing one housing to another are also contemplated by this invention.

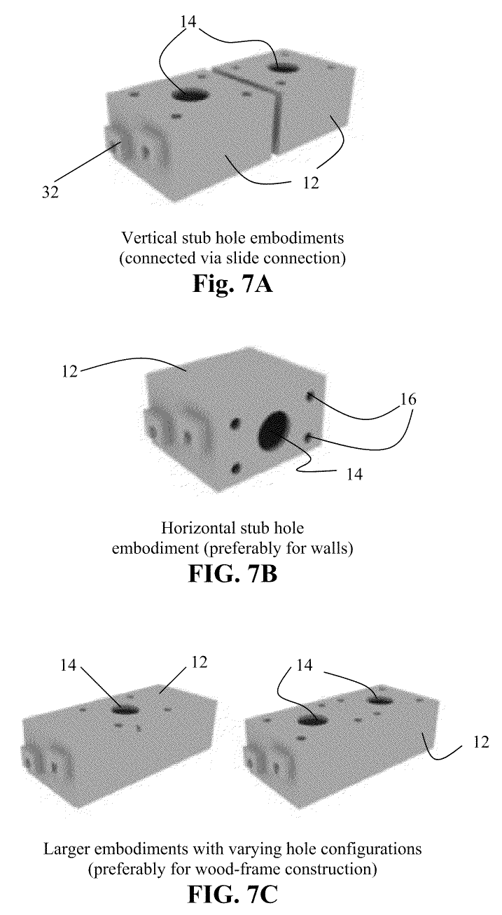

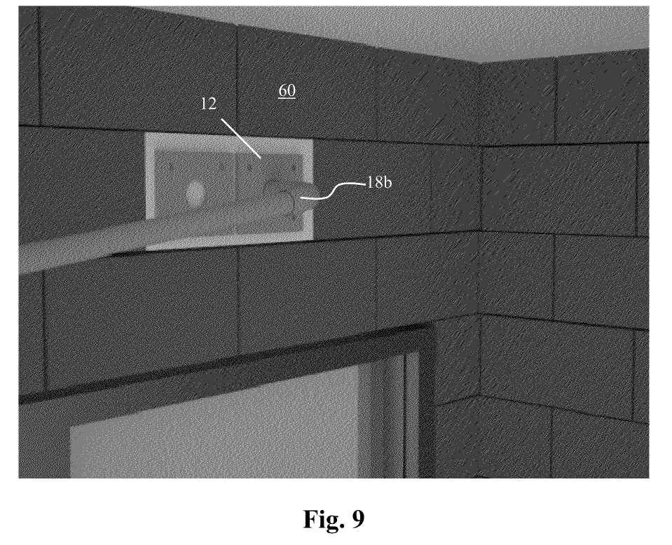

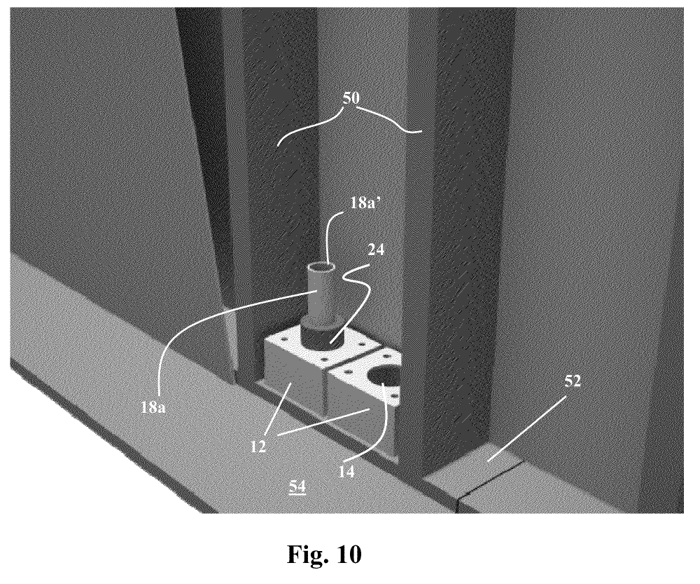

As shown in FIGS. 7-10, housing 12 is preferably configurable in a variety of dimensions according to standard, commonly used construction systems. FIGS. 7A through 7C show alternative embodiments of the Plumb Box invention that vary in dimensions according to specific construction systems. The stub holes 14 can also vary in quantity, position and diameter, according to standard piping and conduit sizes, or customized for specific building projects. As shown in FIGS. 7A and 10, two housings 12 can be coupled together. The two housings are connected via connector mechanism 30, 32. As shown in FIGS. 7B and 9, the housing 12 can be oriented and configured according to the specific needs of the building site. In this instance, stub opening 14 and openings 16 are provided on the vertical side surface of housing 12 to accommodate a horizontal installation preferably used in a wall surface installation. FIG. 7C depicts housings 12 of a larger dimension wherein the housing may be provided with a single stub opening 14 (left figure) or with two or more opening 14 (right figure). Such larger configurations are typically preferred in wood-frame constructions.

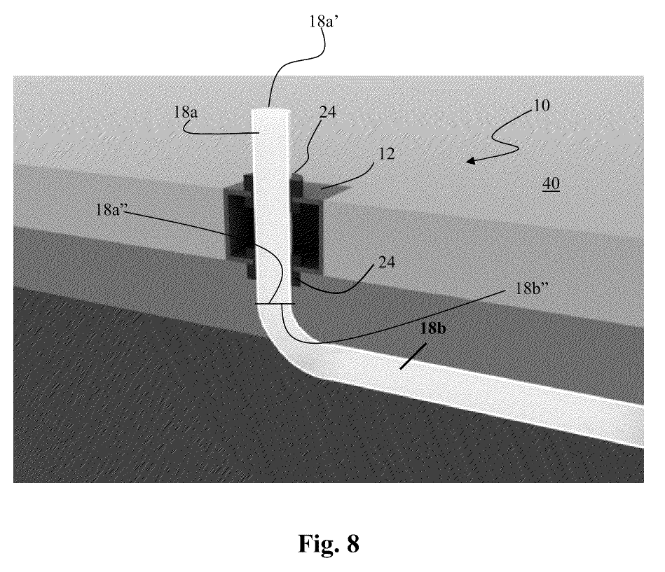

As noted above, housing 12 is preferably positioned within the floor, wall or ceiling surface, respectively, through which the pipe or conduit extends. FIG. 8 shows the Plumb Box apparatus 10 installed within a concrete slab floor 40. As noted, stubs 18 are not limited to specific alignments within the unit, diameters, cross-sections or quantity. In this instance, the top surface of housing 12 is aligned or flush with the top surface of the floor 40, and stub 18a extends above the floor for future connection to a vertically aligned piping system, while stub 18b extends at a transverse angle beneath the floor 40 for connecting to a horizontally aligned piping system. This embodiment is particularly useful for transitioning between vertically aligned piping systems within a building and horizontally aligned drainage piping located beneath the building.

As previously noted, FIG. 9 depicts the Plumb Box apparatus 10 having transition stub 18b installed within a standard concrete masonry unit wall 60. In this embodiment, the preferred structure comprises two housings 12 coupled together, which in combination are approximately the same dimension as a standard concrete masonry unit for ease of installation. This application is useful for running piping or conduits horizontally through walls in specific locations as specified by the architect or contractor. In this embodiment, the device is installed simultaneously with the concrete masonry units as part of the overall wall system and secured within the wall with the same component (i.e. grout) used in masonry construction. This embodiment is also useful for retrofitting existing masonry construction walls where plumbing for mechanical systems needs to be routed through an existing wall structure.

FIG. 10 is a depiction of an embodiment of this invention comprising two housings 12 coupled together installed within a standard wood-frame construction wall system. In this embodiment, the dimensions of the ultimate housing structure are sized appropriately for fitting between wood-frame studs 50, which are typically spaced 16 inches on center. The housings 12 rest on the bottom wood plate 52, just above the floor surface 54, and allow for a vertically oriented piping system to connect from the top of the housing via the open distal end 18a′ of stub 18a.

The housing 12 of this invention is preferably constructed from a precast or molded, structurally stable material, such as plastic, resin or other polymer, and in accordance with the relevant building codes. The preferred shape of housing 12 is a box-like shape, with the option for adjustment, customization or re-sizing for specific building projects. Once the piping stubs 18a and/or 18b are installed in combination with the grommets 24, the remaining hollow cavities within the housing 12 may be filled with expandable insulation foam (see infill 13 in FIG. 3) or some other material to create a rigid substrate within the interior of housing 12 that resists thermal transfer. As noted above, the number and size of stub openings 14 can be varied to accommodate pipe placements of varying configurations and cross-sections, and may be determined on a case-by-case basis prior to construction, relying on customized pipe fittings as well as standardized models. Average sizes for housing 12 include 8×8×16 inches for masonry construction, and 1.5×3×14.5 inches for wood-frame construction. The typical shapes of stub holes 14 include circular, square, oval or other possible cross-sections as desired. Other embodiments of the Plumb Box invention may consist of multiple openings of various dimensions, aligned in the center of the housing 12 or in combinations suitable for specific pipes and their variations (electrical, plumbing, cable, etc.).

While the illustrations and descriptions provided with this document are intended to represent the proposed invention and the principles inherent in it use, the designs are intended to be illustrative and not restrictive in nature. The aforementioned materials represent a limited number of examples or embodiments of the pipe alignment device of this invention. The embodiments shown represent the most likely designs and methods of use, as well as the best requirements for meeting these objectives. It is understood that multiple variations and modifications are possible for the described embodiments, and it would be impractical to attempt to describe or illustrate all such possibilities. It is understood that all changes and alterations are made within the spirit of the claimed technology, and as such, they are also to be protected hereunder.

What is claimed is:

1. An apparatus for providing vertical or horizontal alignment to a pipe or conduit extending through a floor, wall or ceiling surface, said apparatus comprising a housing member having a first set of one or more openings in the surface thereof and one or more pipe stub members for extending though the one or more openings of said housing member, wherein said housing member is positioned within the floor, wall or ceiling surface, respectively, through which said pipe or conduit is to extend.

2. The alignment apparatus of claim 1 further comprising means for stabilizing said housing member in a fixed position within said floor, wall or ceiling surface.

3. The alignment apparatus of claim 2 further comprising one or more stabilizing members and wherein said housing member comprises a second set of openings in the surface thereof for receiving said one or more stabilizing members therethrough to fix the housing member in position.

4. The alignment apparatus of claim 1 further comprising means for securing said one or more pipe stub members within the first set of one or more openings of said housing member.

5. The alignment apparatus of claim 4 wherein said means for securing said one or more pipe stub members within the first set of one or more openings of the housing member comprises one or more elastomeric grommets or washers.

6. The alignment apparatus of claim 1 further comprising means for providing a fluid-tight seal between said one or more pipe stub members and the housing member.

7. The alignment apparatus of claim 6 wherein said means for providing a fluid-tight seal between said one or more pipe stub members and said housing member comprises one or more elastomeric grommets or washers.

8. The alignment apparatus of claim 1 wherein housing member includes a connector for connecting a first housing member to a second housing member.

9. The alignment apparatus of claim 1 wherein said one or more pipe stub members has a linear shape.

10. The alignment apparatus of claim 1 wherein said one or more pipe stub members has a non-linear shape.

11. The alignment apparatus of claim 10 wherein said one or more pipe stub members has a first end with a central axis and a second opposing end with a central axis, and wherein the first central axis is transverse to the second central axis.

12. The alignment apparatus of claim 10 wherein said one or more pipe stub members has a first end with a central axis and a second opposing end with a central axis, and wherein the first central axis intersects the second central axis at an acute or obtuse angle.

13. The alignment apparatus of claim 1 further comprising infill material arranged internally of said housing member to improve the stability of said alignment apparatus.

14. The alignment apparatus of claim 1 wherein said first set of openings and said one or more pipe stub members each have a circular cross-section.

15. The alignment apparatus of claim 1 wherein said first set of openings and said one or more pipe stub members each have a square cross-section.

16. The alignment apparatus of claim 1 wherein said first set of openings and said one or more pipe stub members each have an oval or elliptical cross-section.

17. An apparatus for providing vertical or horizontal plumb alignment to a pipe or conduit extending through a floor, wall or ceiling surface, said apparatus comprising:
a housing having a first set of one or more openings in the outer surface thereof, said housing adapted to be positioned within the floor, wall or ceiling surface, respectively, through which said pipe or conduit is to extend;
one or more pipe stubs for extending though the one or more openings of said housing, wherein said pipe or conduit extends partially into an open end of said pipe stub; and
one or more elastomeric members for securing said one or more pipe stubs within the first set of one or more openings of said housing.

18. The alignment apparatus of claim 17 further comprising one or more stabilizers for securing said housing in a fixed position within said floor, wall or ceiling surface, and wherein said housing includes a second set of openings in the surface thereof for receiving therethrough said one or more stabilizers to thereby fix said housing n position.

19. The alignment apparatus of claim 17 wherein said housing includes one or more connectors for connecting a first housing to one or more other housings.

20. The alignment apparatus of claim 17 wherein said first set of openings and said one or more pipe stubs each have a circular cross-section.

21. The alignment apparatus of claim 17 wherein said first set of openings and said one or more pipe stubs each have a square cross-section.

22. The alignment apparatus of claim 17 wherein said first set of openings and said one or more pipe stubs each have an oval or elliptical cross-section.

23. A method for providing vertical or horizontal alignment to a pipe or conduit extending through a floor, wall or ceiling surface, said method comprising:
providing a housing having a first set of one or more openings in the outer surfaces thereof, said housing adapted to be positioned within the floor, wall or ceiling surface, respectively, through which said pipe or conduit is to extend;
providing one or more pipe stub members for extending though the first set of one or more openings of said housing, said pipe stub members having a first open proximal end and opposing open distal end;
extending said pipe or conduit partially into the open distal ends of the pipe stub members; and
securing said pipe stub members within the one or more openings of said housing; and

24. The piping alignment method of claim 23 further comprising the step of stabilizing said housing in a fixed position within said floor, wall or ceiling surface.

25. The piping alignment method of claim 24 wherein said stabilizing step includes:
providing one or more elongated stabilizing members;
providing a housing comprising a second set of openings in the surfaces thereof, and
inserting said one or more elongated stabilizing members through said second of openings of the housing to fix said housing in position within said floor, wall or ceiling surface.

26. The piping alignment method of claim 23 wherein said step of securing said pipe stub members within the first set of one or more openings of said housing comprises placing one or more elastomeric grommets interposed between the pipe stub members and the housing.

27. The piping alignment method of claim 23 further comprising the step of providing a fluid-tight seal between said one or more pipe stub members and the housing.

28. The piping alignment method of claim 23 further comprising the steps of:
providing said housing having a connector affixed thereto;
providing a second housing having a corresponding connector affixed thereto; and
connecting said first housing to said second housing.
